(19) United States
(12) Patent Application Publication
(10) Pub. No.: US 2003/0043882 A1
(43) Pub. Date: Mar. 6, 2003

(54) Arrangement for picking up and/or setting down, and method of detecting, movable components

(76) Inventors: Stefan Burger, Muenchen (DE); Harald Stanzl, Muenchen (DE)

Correspondence Address: HARNESS, DICKEY & PIERCE, P.L.C., P.O.BOX 8910, RESTON, VA, 20195, US

(21) Appl. No.: 10/202,084

(22) Filed: Jul. 25, 2002

(30) Foreign Application Priority Data
Aug. 29, 2001 (DE) 10142269.5

(51) Int. Cl. G01K 1/16

(52) U.S. Cl. 374/141; 374/163

(57) ABSTRACT

Disclosed is an arrangement for making it possible to pick up movable components for transporting purposes and/or to set them down in order to place them for example on a device which is to be produced. Therefore, a measuring arrangement may reliably measure the presence of the movable component at an opening of a tubular element. The measuring arrangement here measures, on the basis of a temperature measurement, the gas through flow through the tubular element, which, in turn, can be related directly to the presence or absence of a component at the opening.

This application claims priority of German Patent Application No. 10142269.5, filed Aug. 29, 2002, the entire contest of which are hereby incorporated by reference.

### FIELD OF THE INVENTION

The present invention generally relates to an arrangement for picking up and/or setting down movable components as are utilized, for example, for pick-and-place machines for fitting out a substrate with electrical components.

### BACKGROUND OF THE INVENTION

Increasing cost pressures in many areas of mass production have resulted in the transportation of movable components from the storage location to an assembly location being automated. In device construction, this operation is carried out by pick-and-place machines. In pick-and-place machines, a pick-and-place head is used to remove components from a feed unit and position them at predetermined locations on substrates.

Such a pick-and-place machine for constructing electronic printed circuit boards or other substrates is described, for example, in international patent application WO 00/67544. In order for the components to be positioned correctly on the substrate, the position of the components on the pick-and-place head is determined with the aid of sensors. A control device of the pick-and-place machine then controls, in dependence on the position determined for the components, the pick-and-place head parallel to the plane of the substrate such that correct positioning takes place. For the highest possible level of flexibility for the operation of picking and placing different components on different substrates, some of the constituent parts of a pick-and-place machine are of exchangeable design. There are thus, for example, pick-and-place heads which can pick up a plurality of components, and then set down the picked-up components one after the other at the predetermined positions on the substrate without first having to be displaced again to the feed units in between. This results in a high pick-and-place performance, i.e. in a high number of components which are picked and placed per unit of time.

A critical operation for fitting out a substrate is that of picking up the movable components in the feed unit and setting down the movable components on the substrate. The picking-up operation has to be carried out with precise guidance of the pick-and-place head, in order for it to be possible to prevent damage to the often sensitive components. Furthermore, a component has to be picked up and set down in a short period of time, in order that these operations do not become time-limiting factors in the pick-and-place performance.

Mechanical grippers or suction pipettes arranged on the pick-and-place head are usually used for picking up and setting down the movable components. Suction pipettes have the advantage that they can pick up movable components, irrespective of the geometrical shape thereof, as long as the top side of the components has a sufficiently large smooth surface on which the suction pipette can produce a negative pressure. Furthermore, a comparatively straightforward miniaturization of suction pipettes makes it possible to pick up even very small components, as are increasingly common in electronics assembly in particular.

For a correct pick-and-place operation, furthermore, it is necessary to detect absolutely reliably whether a component is seated correctly on the gripper or on the suction pipette. As far as suction pipettes are concerned, in the case of current configurations of pick-and-place heads, the presence of components is established via a pressure sensor on the pipette. If the pressure drops below a certain level, this indicates that a component has been picked up by the suction pipette.

This principle, however, becomes more unreliable as the size of the components used and of the suction pipettes used decreases. This is caused by the ever-decreasing through flow through the suction pipette. The evaluatable pressure signal—with the pipette open and with the pipette closed by the component—becomes smaller and smaller and is also influenced by disturbances to an increasing extent. In order to compensate for the lack of reliability of the prior-art system, a relatively high-outlay optical sensor was arranged downstream of it, this sensor further checking the picking-up operation by shadow formation.

### SUMMARY OF THE INVENTION

An object of an embodiment of the present invention is thus to provide an arrangement which is intended for picking up and/or setting down movable components and which can measure the presence of a movable component on this arrangement without the above described disadvantages.

This object is achieved by the arrangement according to independent claim 1 and by a method having the features according to claim 22. Further advantageous embodiments, configurations and aspects of the present invention can be gathered from the dependent patent claims, the description and the attached drawings.

An embodiment of the present invention provides an arrangement for picking up and/or setting down movable components which has the following features:

a tubular element which can pick up a movable component by means of negative pressure at an opening of the tubular element;

a measuring arrangement for measuring the presence of the movable component at the opening, the measuring arrangement having at least one heating element and at least a first temperature-measuring element.

The arrangement according to an embodiment of the invention serves for making it possible to pick up movable components for transporting purposes and/or to set them down in order to place them for example on a device which is to be produced, it being possible for the measuring arrangement reliably to measure the presence of the movable component at the opening of the tubular element. The measuring arrangement here measures, on the basis of a temperature measurement, the gas through flow through the tubular element (gas mass-flow sensor), which, in turn, can be related directly to the presence or absence of a component at the opening. The arrangement according to the invention has the advantage that, even in the case of small tubular elements, the measuring arrangement supplies a large measuring signal which is easy to evaluate. Furthermore, the measuring arrangement makes it possible to realize very short response times, and the measuring signal is subjected to considerably lower levels of disturbance than was the case with the prior-art pressure measurements. Since the output signal of the measuring arrangement depends directly on the gas through flow through the tubular element, it is also possible, in the case of the arrangement according to the invention, to obtain additional information on the state of the tubular element, e.g. on the contamination of the tubular element.

A reliable measurement of the presence of the movable component at the opening of the tubular element is an important precondition for correct assembly of devices. The present invention is advantageous, in particular, when the movable components are so small that arrangements for picking up and/or setting down movable components, e.g. suction pipettes, with conventional measuring arrangements have difficulty in measuring the presence of a component.

The term tubular element is to be understood in a wide sense. The tubular element is preferably a largely closed hollow body, with at least two openings, for a gas. One opening here serves for picking up the movable component by means of negative pressure, and the other opening serves for connection to a negative-pressure device which provides a negative pressure, e.g. a vacuum pump or a vessel which is subjected to negative pressure (vacuum reservoir). In a preferred configuration, the tubular element is part of a suction pipette or of a pick-and-place machine.

Movable component, in this context, is any article, in particular an article which constitutes an element for constructing a device. The word “movable” here relates to the fact that, on account of weight or structure of the component, it is easier for the component to be moved to the device than, conversely, for the device to be moved to the component. Component preferably refers to electronic components or approximately equally sized mechanical components of a device which are used to fit out devices or parts of devices such as electronic printed circuit boards or substrates.

The movable component is preferably picked up counter to the gravitational force acting on the component, counter to the acceleration force acting on the component and/or counter to a force by means of which the movable component is retained at its storage location or feed unit. In order for it to be possible to pick up such a component, the force to which the movable component is subjected by the negative pressure has to be greater than the gravitational force and/or the retaining force from the storage location. The negative pressure here is preferably measured relative to the external pressure of the tubular element.

The opening of the tubular element for picking up the movable component is preferably provided at one end of the tubular element, with the result that the opening can easily be positioned on a surface of the movable component. The opening of the tubular element for picking up the movable component is preferably configured such that it can be positioned accurately on an outer side of the movable component. In this way, the opening is largely sealed by the movable component, with the result that, once the movable component has been picked up, the greatest possible negative pressure prevails in the tubular element. As a result, the force by which the movable component is pressed against the tubular element is as large as possible, which allows reliable transportation. The opening for picking up a movable component with the tubular element preferably forms a planar opening border, since in this way the tubular element can be positioned accurately on any movable component with a planar surface region.

The measuring arrangement of the arrangement according to an embodiment of the present invention serves for measuring the presence of the movable component at the opening of the tubular element. This measurement preferably serves for indicating that the movable component has been pressed onto the opening of the tubular element by means of negative pressure and can thus be transported. Such an indication is important in order for it to be possible to ensure that a device or, for example, an electronic printed circuit board is reliably fitted out in automated fashion.

According to a preferred embodiment of the arrangement according to the present invention, the heating element comprises at least one heating resistor. This is a straightforward method of producing a heating means taking up a minimal amount of space. It is possible, in particular, to apply a heating resistor in the form of a layer to the inside of the tubular element, which is advantageous, in particular, for heating very small tubular-element diameters. In addition, it is also possible for the temperature of a heating resistor to be easily controlled by, for example, the voltage applied to the heating resistor being controlled. Furthermore, it is preferred if the temperature-measuring element comprises at least one temperature-measuring resistor. This makes it possible to form, in particular, very small, miniaturized measuring arrangements.

According to a further preferred embodiment of the arrangement according to the present invention, the heating element and the temperature-measuring element are integrated in one element.

The measurement of the presence of a component can preferably be determined in accordance with the principle of a thermal anemometer. It is preferred here in particular if the heating resistor and the temperature-measuring resistor are combined in one resistor. Examples of measured variables which may be used are the heating output which is necessary to achieve a predetermined temperature or the temperature which is set by a predetermined heating output. If a component is present at the opening, then the gas flow through the tubular element decreases, as a result of which the heat loss of the heating element decreases at the same time. Accordingly, the presence of the component can be reliably determined on the basis of the heat loss.

According to a further preferred embodiment of the arrangement according to the present invention, the presence of a component will be determined on the basis of the heat transfer to the gas. It is preferred here in particular if the heating resistor is arranged upstream of the temperature-measuring resistor, as seen in the direction of the gas flow. The heating element heats the gas and the temperature-measuring element registers the heating of the gas, with the result that it is possible to determine the mass flow. It is possible here to heat essentially all of the flowing gas (thermal transfer principle) or, preferably, just a thin boundary layer of the flowing gas (microthermal transfer principle). If only a thin boundary layer of the flowing gas is heated, this achieves a very sensitive method which only requires a low heating output.

According to a further preferred embodiment of the arrangement according to the present invention, the presence of a component can be determined on the basis of a so-called “thermal time-of-flight measurement”. It is preferred here in particular if a control circuit controls the heating output such that heat pulses are produced. The heating element transmits a heat pulse to the gas and, via the temperature-measuring element, it is possible to determine the point in time at which this heat pulse arrives at the temperature-measuring element, which, in turn, allows conclusions to be drawn in respect of the gas flow.

According to a further preferred embodiment of the arrangement according to the present invention, the measuring arrangement has a control circuit which controls the heating output for the heating element. It is preferred here if the control circuit controls the heating output such that the temperature measured via the temperature-measuring element is essentially constant. Accordingly, the measuring arrangement can determine the presence of the movable component at the opening of the tubular element by way of the heating output. Alternatively, it is preferred if the control circuit controls the heating output such that the heating output is essentially constant. Accordingly, the measuring arrangement can determine the presence of the movable component at the opening of the tubular element by way of the temperature measured via the temperature-measuring element.

The preferred heating output for establishing the presence of a component depends on the type of measuring principle used, on the type of heating element, on the diameter of the tubular-element opening, on the type of tubular element and/or on the type of movable component. It is preferred if the heating output is set such that the temperature of the heating element, when a movable component has been picked up, is higher than the surroundings by more than 10° C., preferably more than 30° C. and, if possible, more than 60° C. A higher temperature brings about not just a more sensitive measurement, but also a quicker measurement. The heating output is preferably set such that the presence of the component can be measured in less than 1 second, preferably in less than 100 ms and even more preferably in less than 20 ms.

If the measurement is based on a constant temperature with a variable heating output, then the control circuit preferably controls the heating output such that the measured temperature is controlled with an accuracy of better than plus/minus 5° C., preferably better than plus/minus 2° C. and, if possible, preferably better than plus/minus 1° C. around the constant temperature value. The changeable heating output which is necessary for the temperature stabilization can easily and quickly be measured remote from the tubular element. It is preferable for the operations of picking up and/or setting down the movable components to take place in the free atmosphere, with the result that the gas in the tubular element is preferably air.

According to a further preferred embodiment of the arrangement according to the present invention, a second temperature-measuring element with, preferably, a further temperature-measuring resistor is provided, the additional temperature-measuring resistor being arranged upstream of the heating resistor, as seen in the direction of the gas flow. This second temperature-measuring element serves as a type of reference element, with the result that the changes in temperature caused by the heating element can be better distinguished from external disturbances.

According to a further preferred embodiment of the arrangement according to the present invention, the heating element and the temperature-measuring element are arranged in the interior of the tubular element, in the vicinity of the opening for picking up the movable component. At these locations, the influence to which the heated element is subjected by the gas from the atmosphere outside the tubular element, the gas entering in through the opening from the outside, is greatest. In this way, it is possible to achieve the highest level of sensitivity and the greatest speed for measuring the presence of the component.

According to a further preferred embodiment of the arrangement according to the present invention, the heating element and the temperature-measuring element are arranged outside the tubular element, between the tubular element and a negative-pressure device. This embodiment has the advantage that the measuring arrangement may be provided at a location at which sufficient space is available, which is advantageous, in particular, in the case of small tubular-element diameters.

The opening of the tubular element preferably has a diameter of less than 20 mm, preferably less than 5 mm and even more preferably less than 2 mm. The smaller the movable components, the smaller do the openings of the tubular element for picking up and setting down the movable components also have to be.

### BRIEF DESCRIPTION OF THE DRAWINGS

The invention is illustrated in more detail hereinbelow with reference to figures of the drawings, in which:

FIG. 1 shows a schematic side view of a pick-and-place machine which has an arrangement according to an embodiment the present invention for picking up and/or setting down movable components,

FIG. 2 shows a schematic plan view of the pick-and-place machine from FIG. 1,

FIG. 3 shows a schematic sectional view of a first embodiment of the arrangement according to the present invention for picking up and/or setting down movable components,

FIG. 4 shows a schematic sectional view of a second embodiment of the arrangement according to the present invention for picking up and/or setting down movable components,

FIG. 5 shows a schematic sectional view of a further embodiment of the arrangement according to the present invention for picking up and/or setting down movable components, and

FIG. 6 shows a schematic view of a further embodiment of the arrangement according to the present invention for picking up and/or setting down movable components.

### DETAILED DESCRIPTION OF THE PREFERRED EMBODIMENTS

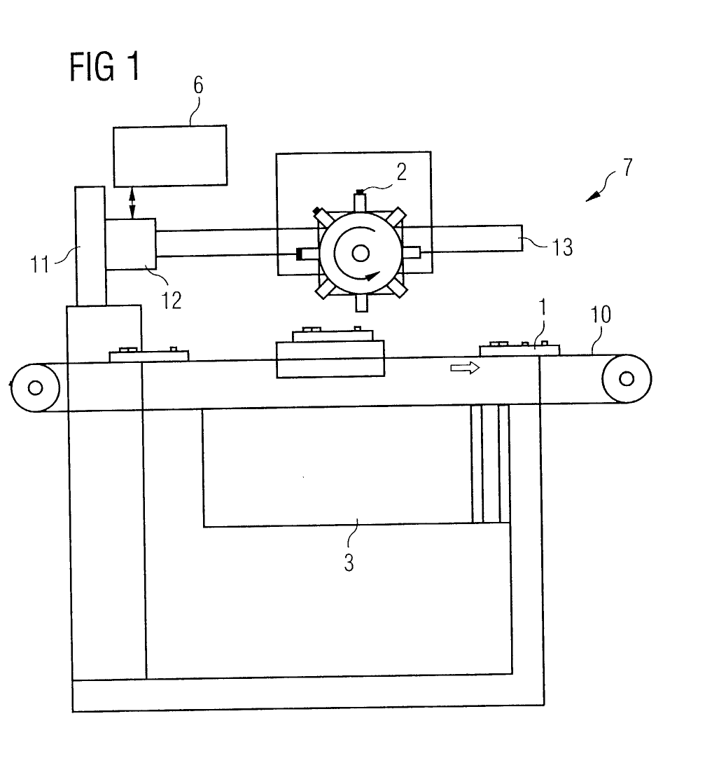

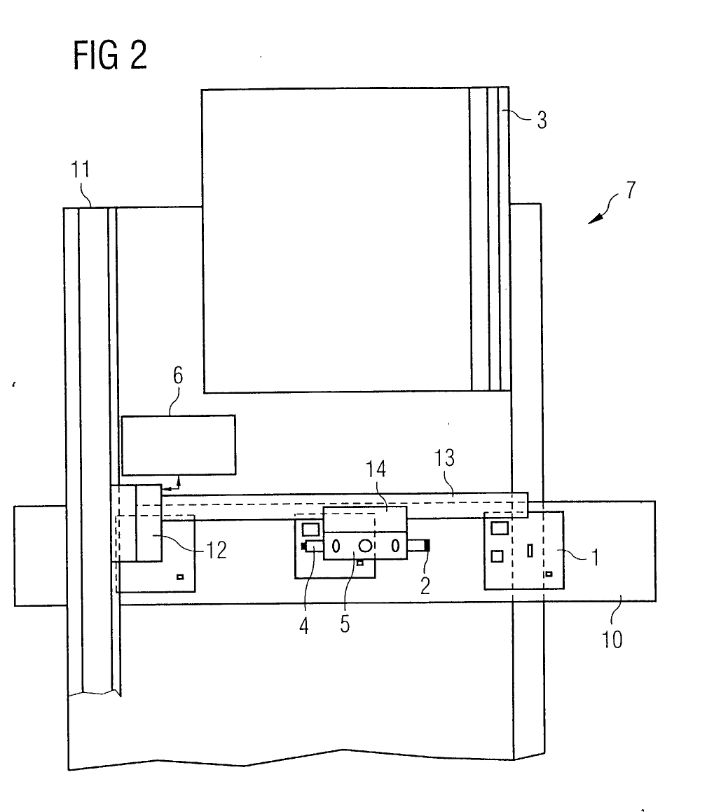

FIG. 1 illustrates a schematic side view of a pick-and-place machine 7, and FIG. 2 illustrates a corresponding schematic plan view. In pick-and-place machines 7, substrates 1 are fitted out with components 2 by the components 2, which are supplied in feed units 3, being picked up on the pick-and-place head 5 by suction pipettes 4, as part of a picking-up and/or setting-down arrangement according to the invention, and then being set down in the predetermined position on the substrate 1.

The pick-and-place head 5 here can be moved essentially parallel to the surface of the substrate 1. For this purpose, use is made of a first rail 11, on which a first carriage 12 is fastened in a movable manner. A second rail 13, on which a second carriage 14 moves, is fastened on said first carriage 12 essentially perpendicularly to the first rail 11. Said second carriage 14 is connected to the pick-and-place head 5.

A control device 6 moves the first carriage 12 on the second carriage 14 such that the pick-and-place head 5 is moved to the feed units 3 and, once it has picked up a component 2, is moved essentially parallel to the surface of the substrate 2. A transporting device 10 serves for transporting the substrates 1 into the pick-and-place machine 7, as far as the pick-and-place position, and out of the pick-and-place machine 7 again.

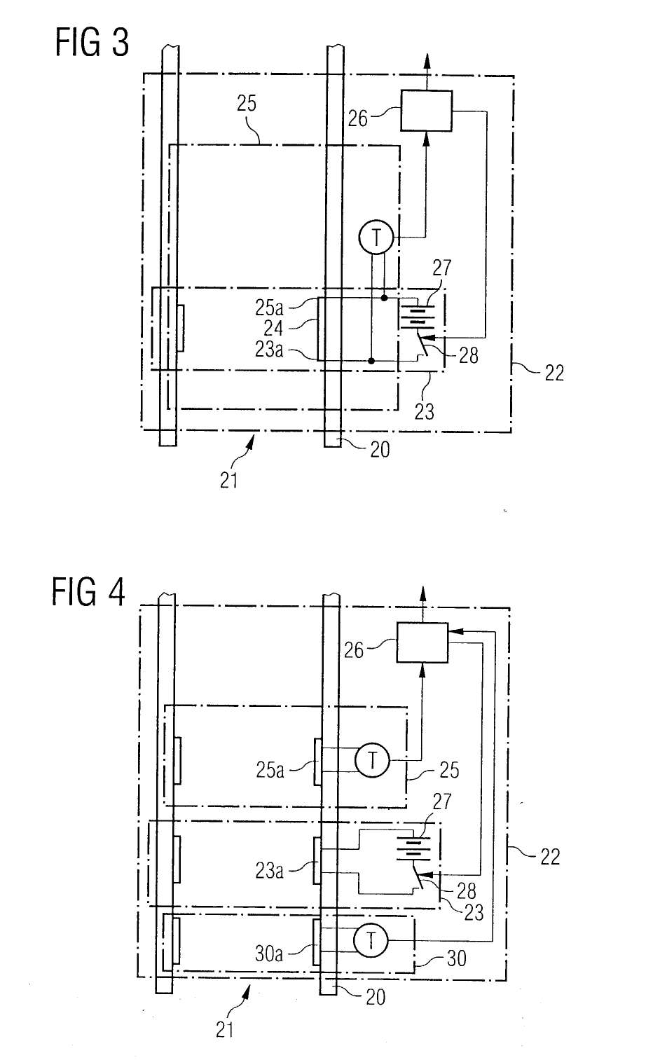

FIG. 3 shows a schematic side view of a first embodiment of the arrangement according to the invention for picking up and/or setting down movable components. In this case, the arrangement according to the invention for picking up and/or setting down movable components comprises a tubular element 20 which can pick up a movable component 2 by means of negative pressure at an opening 21 of the tubular element 20. In the embodiment shown in FIG. 3, the tubular element 20 is, for example, a 0201 pipette, i.e. a pipette which is suitable for components with edge lengths of 0.02 inches×0.01 inches, corresponding to approximately 0.5 mm×0.25 mm.

Furthermore, the arrangement according to the invention for picking up and/or setting down movable components comprises a measuring arrangement 22 for measuring the presence of the movable component at the opening, the measuring arrangement 22 having a heating element 23 and a temperature-measuring element 25. In this case, the heating element 23 is essentially formed by the heating resistor 23a, which is arranged as a metal layer 24 on the inside of the tubular element. At the same time, the metal layer 24 acts as a temperature-measuring resistor 25a, which essentially forms the temperature-measuring element 25. In the case of this embodiment, the heating resistor 23a and temperature-measuring resistor 25a are thus integrated in one resistor, the metal layer 24.

In the case of the embodiment shown in FIG. 3, the heating element 23 and the temperature-measuring element 25 are essentially arranged in the interior of the tubular element 20, in the vicinity of the opening 21 for picking up the movable component 2. At these locations, the influence to which the metal layer 24 is subjected by the gas from the atmosphere outside the tubular element, the gas entering in through the opening 21 from the outside, is greatest. In this way, it is possible to achieve the highest level of sensitivity and the greatest speed for measuring the presence of the component, which is advantageous in particular for very small tubular elements with small openings.

As can be seen from FIG. 3, the measuring arrangement 22 has a control circuit 26, which controls the heating output, via a switch 28, in dependence on the temperature measured by the temperature-measuring element 25. The metal layer 24 here is supplied with power via a power/voltage source 27. With the aid of the switch 28, the metal layer 24 can be used, in cyclic operation, alternately as a heating resistor 23a and a temperature-measuring resistor 25a.

The control circuit 26 here controls the heating output such that the measured temperature is essentially constant. In the present example, the temperature is kept constant at approximately 100° C. As a result, with the pipette closed, i.e. in the presence of a component, a heating output of 650 mW is necessary in order to keep the metal layer 24 at this temperature. If the pipette is open, i.e. in the absence of a component, then a heating output of 900 mW is necessary in order to keep the metal layer 24 at this temperature. This increased heating output is attributable to the cooling of the metal layer 24 being increased by the gas flow. The presence of a component at the opening of the pipette can be detected quickly and reliably by way of the marked difference in the heating output.

The measuring arrangement 22 thus measures, on the basis of a temperature measurement in accordance with the principle of a thermal anemometer, the gas through flow through the tubular element 20 (gas mass-flow sensor), which, in turn, can be related directly to the presence or absence of a component at the opening. The arrangement according to the invention has the advantage that, even in the case of small tubular elements with small internal diameters, the measuring arrangement supplies a large measuring signal which is easy to evaluate. Furthermore, the measuring arrangement makes it possible to realize very short response times, and the measuring signal is subjected to considerably lower levels of disturbance than was the case with the prior-art pressure measurements. Since the output signal of the measuring arrangement depends directly on the gas through flow through the tubular element, it is also possible, in the case of the arrangement according to the present invention, to obtain additional information on the state of the tubular element, i.e. on the contamination of the tubular element.

FIG. 4 shows a schematic sectional view of a second embodiment of the arrangement according to the present invention for picking up and/or setting down movable components. In contrast to the embodiment shown in FIG. 3, in the case of the embodiment shown in FIG. 4, the heating resistor 23a and the temperature-measuring resistor 25a are no longer integrated in a single metal layer 24; rather, the heating resistor 23a is arranged upstream of the temperature-measuring resistor 25a, as seen in the direction of the gas flow.

In the case of this embodiment shown in FIG. 4, the presence of a component can be determined on the basis of the heat transfer to the gas. The heating element 23 heats the gas and the temperature-measuring element 25 registers the heating of the gas, with the result that it is possible to determine the mass flow. It is possible here to heat essentially all of the flowing gas (thermal transfer principle) or, preferably, just a thin boundary layer of the flowing gas (microthermal transfer principle). If only a thin boundary layer of the flowing gas is heated, this achieves a very sensitive method which only requires a low heating output.

In addition, in the case of the embodiment shown in FIG. 4, a second temperature-measuring element 30 with a temperature-measuring resistor 30a is provided. The additional temperature-measuring resistor 30a here is arranged upstream of the heating resistor 23a, as seen in the direction of the gas flow. This second temperature-measuring element 30 serves as a type of reference element, with the result that the changes in temperature caused by the heating element 23 can be better distinguished from external disturbances.

FIG. 5 shows a schematic sectional view of a further embodiment of the arrangement according to the present invention for picking up and/or setting down movable components. In contrast to the embodiment shown in FIG. 3, in the case of the embodiment shown in FIG. 5, it is again the case that the heating resistor 23a and the temperature-measuring resistor 25a are no longer integrated in a single metal layer 24; rather, the heating resistor 23a is arranged upstream of the temperature-measuring resistor 25a, as seen in the direction of the gas flow.

In the case of this embodiment shown in FIG. 5, the presence of a component can be determined on the basis of a so-called “thermal time-of-flight measurement”. The control circuit 26 here controls the heating output such that heat pulses are produced. The heating element 23 transmits a heat pulse to the gas and, via the temperature-measuring element 25, it is possible to determine the point in time at which this heat pulse arrives at the temperature-measuring element 25, which, in turn, allows conclusions to be drawn in respect of the gas flow.

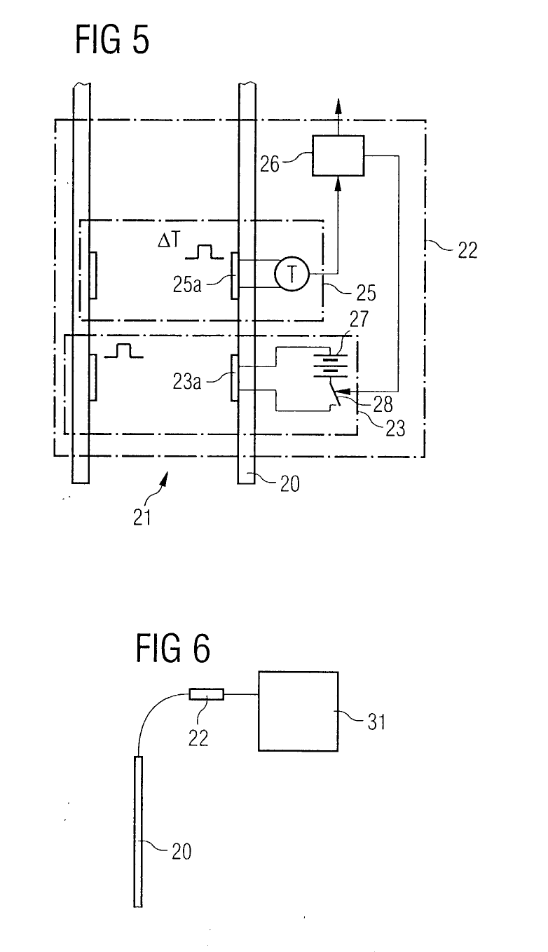

In the case of those embodiments of the arrangement according to the present invention for picking up and/or setting down movable components which have been shown up until now, the measuring arrangement is arranged essentially within the tubular element 20 in each case. According to a further preferred embodiment of the arrangement according to the present invention, which is shown schematically in FIG. 6, the heating element and the temperature-measuring element are arranged outside the tubular element 20, between the tubular element 20 and a negative-pressure device 31. This embodiment has the advantage that the measuring arrangement 22 may be provided at a location at which sufficient space is available, which is advantageous, in particular, in the case of small tubular-element diameters.

Furthermore, this embodiment makes it possible to use measuring arrangements which have already been prefabricated, as are produced, for example, by Hahn-Schickard-Gesellschaft (Villingen-Schwenningen). In the case of this embodiment, both the heating element and the first and/or second temperature-measuring elements are integrated in a single semiconductor component.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An arrangement for picking up and/or setting down movable components, comprising:
a tubular element which can pick up a movable component by way of negative pressure at an opening of the tubular element;
a measuring arrangement for measuring the presence of the movable component at the opening, the measuring arrangement having at least one heating element and at least a first temperature-measuring element.

2. The arrangement as claimed in claim 1, wherein the heating element includes a heating resistor.

3. The arrangement as claimed in claim 1, wherein the temperature-measuring element includes a temperature-measuring resistor.

4. The arrangement as claimed in claim 1, wherein the heating element and the temperature-measuring element are integrated in one semiconductor element.

5. The arrangement as claimed claim 1, wherein the measuring arrangement for measuring the presence of the movable component at the opening operates in accordance with the principle of a thermal anemometer.

6. The arrangement as claimed in claim 1, wherein the measuring arrangement for measuring the presence of the movable component at the opening operates in accordance with the heat-transfer principle.

7. The arrangement as claimed in claim 1, wherein the measuring arrangement for measuring the presence of the movable component at the opening operates in accordance with the principle of a time-of-flight measurement.

8. The arrangement as claimed in claim 1, wherein a second temperature-measuring element is provided.

9. The arrangement as claimed in claim 1, wherein the measuring arrangement has a control circuit which controls the heating output for the heating element.

10. The arrangement as claimed in claim 9, wherein the control circuit controls the heating output such that the temperature measured via the temperature-measuring element is substantially constant.

11. The arrangement as claimed in claim 10, wherein the measuring arrangement measures the presence of the movable component at the opening of the tubular element by way of the heating output.

12. The arrangement as claimed in claim 9, wherein the control circuit controls the heating output such that the heating output is essentially constant.

13. The arrangement as claimed in claim 12, wherein the measuring arrangement measures the presence of the movable component at the opening of the tubular element by way of the temperature measured via the temperature-measuring element.

14. The arrangement as claimed in claim 9, wherein the control circuit controls the heating output such that heat pulses are produced.

15. The arrangement as claimed in claim 14, wherein the measuring arrangement measures the presence of the movable component at the opening of the tubular element by way of the time of flight of the heat pulse.

16. The arrangement as claimed in claim 1, wherein the heating element and the temperature-measuring element are arranged in the interior of the tubular element, in the vicinity of the opening for picking up the movable component.

17. The arrangement as claimed in claim 1, wherein the tubular element is connected to a negative-pressure device.

18. The arrangement as claimed in claim 17, wherein the heating element and the temperature-measuring element are arranged outside the tubular element, between the tubular element and the negative-pressure device.

19. The arrangement as claimed in claim 1, wherein the opening of the tubular element has a diameter of less than 20 mm.

20. The arrangement as claimed in claim 1, wherein the tubular element is part of a suction pipette.

21. The arrangement as claimed in claim 1, wherein the tubular element is part of a pick-and-place machine.

22. A method of detecting movable components on an arrangement as claimed in claim 1, the method comprising:
picking up a movable component by way of negative pressure,
determining the gas through flow through the tubular element by way of the measuring arrangement, and
detecting, by virtue of the measured through flow being compared with a reference through flow, whether a movable component has been attached by suction to the tubular element.

23. The arrangement as claimed in claim 2, wherein the temperature-measuring element includes a temperature-measuring resistor.

24. The arrangement as claimed in claim 2, wherein the heating element and the temperature-measuring element are integrated in one semiconductor element.

25. The arrangement as claimed in claim 3, wherein the heating element and the temperature-measuring element are integrated in one semiconductor element.

26. The arrangement as claimed in claim 2, wherein a second temperature-measuring element is provided.

27. The arrangement as claimed in claim 3, wherein a second temperature-measuring element is provided.

28. The arrangement as claimed in claim 4, wherein a second temperature-measuring element is provided.

29. The arrangement as claimed in claim 2, wherein the measuring arrangement has a control circuit which controls the heating output for the heating element.

30. The arrangement as claimed in claim 3, wherein the measuring arrangement has a control circuit which controls the heating output for the heating element.

31. The arrangement as claimed in claim 1, wherein the opening of the tubular element has a diameter of less than 5 mm.

32. The arrangement as claimed in claim 1, wherein the opening of the tubular element has a diameter of less than 2 mm.
